(19) United States
(12) Patent Application Publication
(10) Pub. No.: US 2007/0065056 A1
(43) Pub. Date: Mar. 22, 2007

(54) Guide rail with dovetail attachment

(76) Inventors: Roland Greubel, Ramsthal (DE); Ernst Albert, Sand am Main (DE); Stefan Dorn, Arnstein (DE); Michael Klein, Grafenrheinfeld (DE); Mario Ziegler, Bergtheim (DE); Carsten Pfeuffer, Roethlein (DE); Werner Keller, Schwemmelsbach (DE)

Correspondence Address: STRIKER, STRIKER & STENBY, 103 EAST NECK ROAD, HUNTINGTON, NY, 11743, US

(21) Appl. No.: 11/522,222

(22) Filed: Sep. 15, 2006

(30) Foreign Application Priority Data
Sep. 20, 2005 (DE) 10 2005 044 822.4

(51) Int. Cl. F16C 33/00

(52) U.S. Cl. 384/59

(57) ABSTRACT

With a guide rail system composed of a guide rail with undercuts and a clamp bar, the ratio kₕ=h^{1.5}/b is between 0.2 and 0.5, where b is the width of the base surface, and h is the minimum distance between the holding surface and the base surface of the guide rail, and when the ratio is in this range, guidance inaccuracies are reduced.

### BACKGROUND OF THE INVENTION

The present invention relates to a guide rail for supporting a carriage, a clamp bar for securing the guide rail, and a guide rail system that includes the guide rail and the clamp bar.

Guide rail systems of this type, as made known, e.g., in DE 103 28 336 A1, are composed of a superassembly with a recess, the guide rail, and a clamp bar for securing the guide rail in the recess. As shown in FIG. 1, guide rail 30 includes a guide section 32 with bearing surfaces 36 for supporting the not-shown carriage, and a fastening section 34. Fastening section 34 has a base surface 38 and an undercut 40 with a holding surface 42. Base surface 38 is interrupted by a clearance 44 provided to compensate for inaccuracies, particularly surface irregularities in recess 14 of superassembly 12. Width b of the base surface is defined as the entire width of base surface sections 38a and 38b extending past clearance 44. Guide rail 30 typically has a symmetrical configuration, which is why fastening section 34 has a dovetail shape. Holding surface 42 and base surface 38 are preferably flat.

Clamp bar 70 bears with a clamping surface 72 against holding surface 42 of the guide rail. At bearing section 74, located on the side opposite to clamp surface 72, the clamp bar bears against superassembly 12 such that a self-supporting region 76 exists between clamping surface 72 and bearing section 74. Through-bores 78 are provided in this region, in which a large number of screw bolts 16—separated by a distance t (see FIG. 2) in direction of motion X of the guide rail—is supported. Screw bolts 16 engage in superassembly 12 and produce the clamping force necessary to fasten the guide rail thereto.

A guide rail system of this type is preferably used when a high path accuracy of the carriage is required. In particular, the carriage pitches slightly, particularly when it moves along the guide rail; pitches are rotational motions around a Y-axis perpendicular to direction of motion X and parallel to the base surface. These pitches are caused—with the otherwise typical screw attachment of the guide rail—by slight guide rail deformations caused by the locally acting screw forces. The bores for the fastening screws that are typically present are outlined in FIG. 1 using dash-dotted lines.

With the current dovetail attachment, however, a recess 14 that is complementary to fastening section 34 is provided in superassembly 10, guide rail 30 being clamped tightly in recess 14 in a form-fit manner using clamp bars 70. Recess 14 typically has a small fillet 18 in its corner to reduce the notch stresses that occur there. It is therefore not possible for holding surface 42 of guide rail 30 to reach base surface 38. According to FIG. 2, instead, a minimum distance h is provided between holding surface 42 and base surface 38, so that flank 46 between holding surface 42 and base surface 38 of the guide rail does not touch recess 14.

Since the clamping forces act nearly evenly across the entire longitudinal extension of the guide rail, an uneven deformation of the guide rail and, as a result, undesired pitches of the carriage are prevented. It has been shown, however, that the unavoidable surface irregularities of the recess along its longitudinal extension cause the carriage to pitch.

### SUMMARY OF THE INVENTION

The object of the present invention, therefore, is to create a guide rail with improved path accuracy.

In keeping with these objects and with others which will become apparent hereinafter, one feature of the present invention resides, briefly stated, in a guide rail provided for supporting a carriage and comprising a fastening section which includes a base surface with a width b and at least one undercut with a holding surface which has a minimum distance to a base surface h and a width c, wherein a ratio kₕ=h^{1.5}/b is between 0.2 and 0.5.

Another feature of the present invention resides, briefly stated in a clamp bar for fastening a guide rail, wherein a clamping surface is provided that is complimentary to the holding surface of the guide rail and has a width e; a bearing section is provided on a side opposite to said clamping surface with which the clamp bar is supportable on a superassembly; and through-bores for screw balls are formed and separated by a distance t between said clamping surface and said bearing section, wherein a ratio kₑ=e/t is between 0.05 and 0.25.

Still a further feature of the present invention resides, briefly stated, in a guide rail system including a guide rail and a clamp bar, wherein a union composed of the guide rail and the clamp bar in a recess of the superassembly with a maximum width b is supported in a recess in lateral direction Y, wherein ratio kₐ=a/t being between 0.4 and 0.7.

When the guide rail, the clamp bar and the guide rail system are designed in accordance with the present invention, they eliminate the above mentioned disadvantages of the prior art.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a front view of an inventive guide rail system;

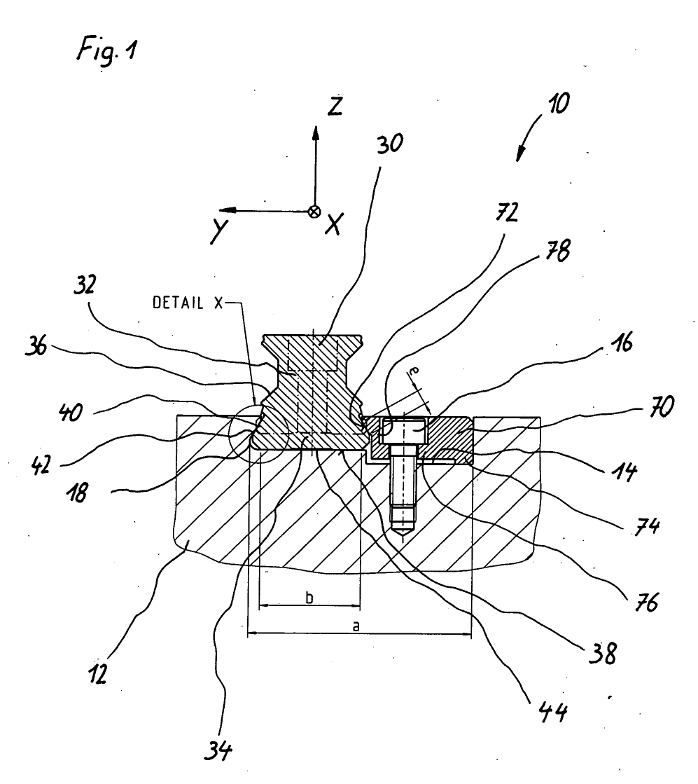

FIG. 2 is a view showing a top view of the guide rail system of FIG. 1 in accordance with the present invention;

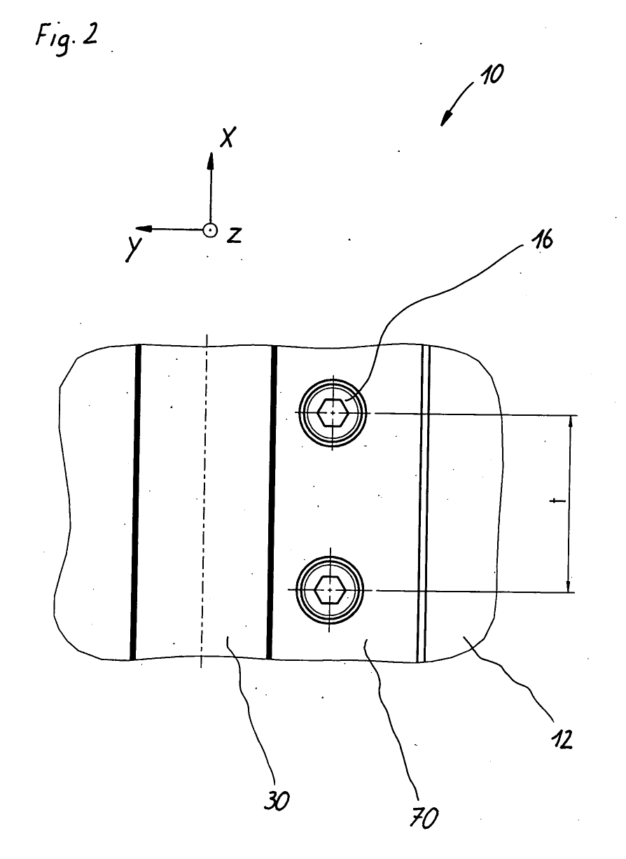

FIG. 3 is a detailed view of an area of the guide rail system labeled “detail X” in FIG. 1 in accordance with the present invention; and

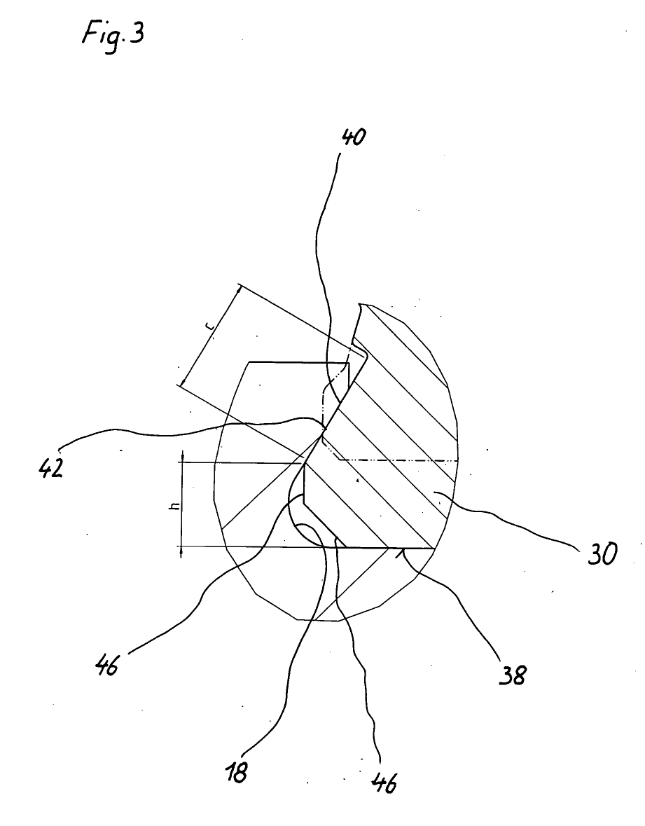

FIG. 4 is a view showing an interrelationship between ratio kₕ, elasticity in lifting direction W_{z} and amplitude of pitch W_{y}, in the form of a diagram.

### DESCRIPTION OF THE PREFERRED EMBODIMENTS

In accordance with the present invention in a guide rail for supporting a carriage, a clamp bar for securing the guide rail, and a guide rail system that includes the guide rail and the clamping bar are provided, with the components disclosed above.

In the guide rail in accordance with the present invention, the ratio kₕ=h^{1.5}/b is between 0.2 and 0.5, and preferably between 0.3 and 0.4.

Ratio kₕ is typically much smaller, since the aim is to design distance h as small as possible, to minimize the overall height of the guide rail and, therefore, the amount of material used. Tests carried out by the applicant have shown, however, that increasing distance h results in greater path accuracy of the guidance. A disadvantage, however, is the fact that elasticity E_{Z} of the guidance decreases as the load lifts, i.e., with a load direction Z perpendicular to the base surface of the guide rail away from the superassembly.

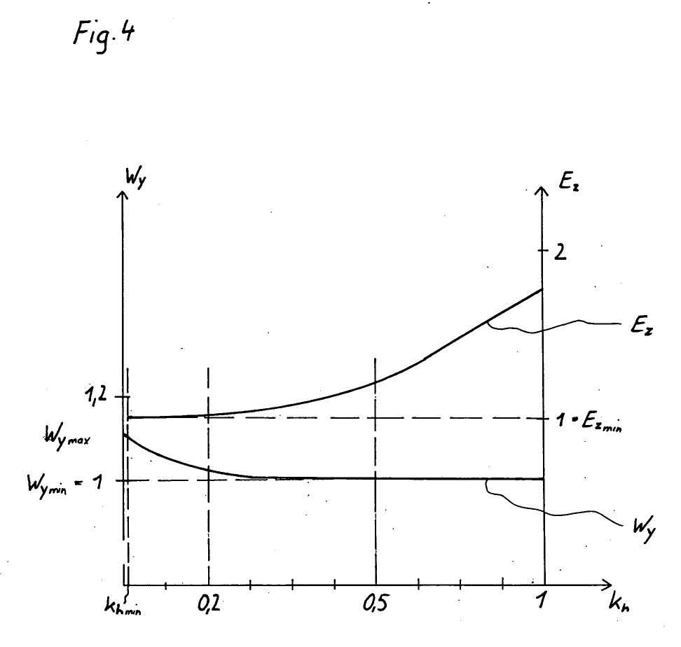

The interrelationship is shown in FIG. 4. In FIG. 4, ratio kₕ=h^{1.5}/b is plotted on the horizontal axis against amplitude W_{Y} of the pitch, and it is plotted on the vertical axis against elasticity E_{Z} in the lifting direction. Values W_{Y} and E_{Z} are plotted without dimensions, and W_{Ymin} and E_{Zmin} were set equal to one. It has been shown that, when the exponent 1.5 is applied for all common guide rail sizes, i.e., for all values of b, nearly equal conditions are attained for all values of b. At very high values of kₕ, curve W_{Y} approaches a minimum value W_{Ymin}, which is caused, among other things, by the finishing inaccuracy of the guide surfaces. As kₕ decreases, the curve increases with a progressive slope until it reaches W_{Ymax}, which is attained at kₕₘᵢₙ, the smallest value that is technically possible. At kₕₘᵢₙ, curve E_{Z} starts with a minimum stiffness E_{Zmin}, which is caused by, among other things, by the stiffness of the rolling elements, when an anti-friction guideway is used.

As kₕ increases, this curve initially increases progressively, then it continues to increase linearly. As shown clearly in FIG. 4, in the inventive range, one attains a particularly good compromise between the least possible elasticity E_{Z} and the highest possible path accuracy of the guidance.

According to a preferred embodiment of the inventive guide rail, ratio k_{c}=c/h² can be between 0.15 and 0.4, and preferably between 0.2 and 0.35. In this range, the width of holding surface c of the guide rail is designed as small as possible, to minimize the overall height of the guide rail and, therefore, the amount of material used. The numerical figures result from strength considerations with regard for the bearing pressure occurring at the clamping surface, and the capacity of the guide rail. The fact that distance h has considerable influence on the evenness of the bearing pressure should be taken into account. The evenness increases as distance h increases.

As has also been shown, the clamp bar for fastening the guide rail influences the path accuracy of the guide rail system. As expected, distance t between the screw bolts used to fasten the clamp bar to the superassembly makes a decisive difference. As expected, the path accuracy increases as the distance between the screw bolts decreases. Surprisingly, it has been shown, however, that there is a lower limit, at which a further reduction in screw distance t and, therefore, greater manufacturing expenditure, bring no further advantages. This limit is in the range in which ratio kₑ=e/t is between 0.05 and 0.25, and preferably between 0.1 and 0.2, where e is the width of the clamping surface that is complementary to the holding surface of the guide rail. In this case, the dimension e is particularly suited to be a reference dimension, because, in combination with the permissible bearing pressure, it is a measure of the clamping forces produced by the screw bolts.

With the entire guide system composed of guide rail, clamp bar and superassembly, ratio kₐ=a/t^{1.3} also influences the path accuracy, with a representing the maximum width of the recess in the superassembly. It has been shown that amplitude W_{Y} of pitch reaches a minimum when kₐ is between 0.4 and 0.7, and preferably between 0.5 and 0.6.

Various exemplary embodiments of the present invention are presented in the table below:

| | Overall size | | |
|---|---|---|---|
| | 35 | 45 | 55 |
| b [mm] | 31.000 | 39.500 | 47.000 |
| h [mm] | 4.768 | 6.073 | 6.604 |
| e [mm] | 4.640 | 7.661 | 8.695 |
| t [mm] | 40.000 | 52.500 | 60.000 |
| a [mm] | 68.676 | 94.371 | 113.530 |
| c [mm] | 7.196 | 9.350 | 11.000 |
| kₕ = h^{1.5}/b | 0.336 | 0.379 | 0.361 |
| kₑ = e/t | 0.116 | 0.146 | 0.145 |
| kₐ = a/t^{1.3} | 0.568 | 0.548 | 0.554 |
| k_{c} = c/h² | 0.317 | 0.254 | 0.252 |

It will be understood that each of the elements described above, or two or more together, may also find a useful application in other types of constructions differing from the type described above.

While the invention has been illustrated and described as embodied in a guide rail with dovetail attachment, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A guide rail for supporting a carriage, comprising a fastening section which includes a base surface with a width b and at least one undercut with a holding surface which has a minimum distance to a base surface h and a width c, wherein a ratio kₕ=h^{1.5}/b is between 0.2 and 0.5.

2. A guide rail as defined in claim 1, wherein said ratio kₕ=h^{1.5}/b is between 0.3 and 0.4.

3. A guide rail as defined in claim 1, wherein a ratio k_{c}=c/h² is between 0.15 and 0.4.

4. A guide rail as defined in claim 3, wherein a ratio k_{c}=c/h² is between 0.2 and 0.35.

5. A guide rail as defined in claim 1, wherein said base surface and said holding surface are configured as flat surfaces.

6. A clamp bar for fastening a guide rail as defined in claim 1; and further comprising a clamping surface that is complimentary to the holding surface of the guide rail and has a width e; a bearing section provided on a side opposite to said clamping surface with which the clamp bar is supportable on a superassembly; and through-bores for screw balls separated by a distance t between said clamping surface and said bearing section, wherein a ratio kₑ=e/t is between 0.05 and 0.25.

7. A clamp bar as defined in claim 6, wherein the ratio kₑ=e/t is between 0.1 and 0.2.

8. A guide rail system including a guide rail as defined in claim 1, and a clamp bar as defined in claim 6, wherein a union composed of the guide rail and the clamp bar in a recess of the super assembly with a maximum width b is supported in the recess in lateral direction Y, wherein ratio kₐ=a/t being between 0.4 and 0.7.

9. A guide rail system as defined in claim 8, wherein the ratio kₐ=a/t is between 0.5 and 0.6.
